(19) United States
(12) Patent Application Publication
(10) Pub. No.: US 2020/0273102 A1
(43) Pub. Date: Aug. 27, 2020

(54) AI FULLY-AUTOMATIC TRADING PLATFORM BASED ON STOCK SPECULATION ROBOT

(71) Applicant: Shanghai Yingshou Information Technology Co., Ltd., Shanghai (CN)

(72) Inventor: Tao CHEN, Shanghai (CN)

(21) Appl. No.: 16/442,346

(22) Filed: Jun. 14, 2019

(30) Foreign Application Priority Data
Feb. 21, 2019 (CN) 201910130159.8

(51) Int. Cl. G06Q 40/04; G06Q 30/02; G06N 20/00

(52) U.S. Cl. CPC G06Q 40/04; G06N 20/00; G06Q 30/0202

(57) ABSTRACT

An AI fully-automatic trading platform based on a stock speculation robot, including a stock analyzing module, a stock data collecting module, a stock model establishing module, a stock screening module, a platform server and a fully-automatic trading platform. An output terminal of the stock analyzing module is connected to an input terminal of the stock data collecting module. An output terminal of the stock data collecting module is connected to an input terminal of the stock model establishing module. An output terminal of the stock model establishing module is connected to an input terminal of the stock screening module. The present invention enables all investors to easily use the technical achievements brought by artificial intelligence innovation technology without writing programs, which is easy to use. In addition, it is possible to enable investors to obtain a yield rate that is countless times stronger than the increase of the large-cap index.

### CROSS-REFERENCE TO RELATED APPLICATIONS

This application claims the benefit of priority from Chinese Patent Application No. CN201910130159.8, filed on Feb. 21, 2019. The content of the aforementioned application, including any intervening amendments thereto, is incorporated herein by reference in its entirety.

### TECHNICAL FIELD

The invention relates to fully-automatic trading, based on artificial intelligence, in global securities, futures, options, foreign exchange and other financial derivatives trading, and more particular to an AI fully-automatic trading platform based on a stock speculation robot.

### BACKGROUND

Up to now, the design of multi-factor fully-automatic trading quantitative model in the field of fully-automatic trading, based on artificial intelligence, in global securities, futures, options, foreign exchange and other financial derivatives trading, is limited to the design methods and ideas of the general US investment community. Due to the limitation of design, most of the factors of the model are designed according to the fundamental surface factor. The annualized yield rate can only reach about the rate of increase of the large-cap index or about one time at most. The annualized yield rate of the model, designed by Peter Lynch who is a world-recognized model designer with the highest level, can only reach about 20% in the past 20 years, while the Dow Jones index rising by about 11%. The quantitative models of China's domestic large securities companies can only reach an annualized yield rate of around 20%.

In addition, the following disadvantages are existed.

1. Due to technical limitations, the methods and ideas for designing the model are not correct, resulting in a low annualized yield rate of the model. Generally, it can only the same as the index or slightly higher.

2. It is not capable of automatically avoiding systemic risks. The systemic risk of a large-cap decline cannot be avoided. The decline range of each wave of the large-cap index will be reflected in the yield rate curve of the model, which is basically the same.

3. A custom function of adding the underlying column is not included, as well as a custom function of setting the bid-ask price.

4. The function is single. It is necessary for users to have the skill of writing their own high-yield trading models, so as to use it. That is, the users shall be those proficient not only in programming but also in securities trading. This will exclude more than 99% of investors from using the fully-automatic trading platform.

5. The entire operation process for completing the trading is very complicated. The users have to click a lot of pages, in order to complete it.

### SUMMARY

In order to overcome the above-mentioned defects of the prior art, an embodiment of the present invention provides an AI fully-automatic trading platform based on stock speculation robot. A stock analyzing module analyzes a stock, which can rise by about 10% in substantially a next week and can reach about 80% or more after rising. A stock data collecting module collects technical indexes and data at the closing of the stock selected. A stock model establishing module designs a model, back-tests, by using the model, historical data in past 5 to 10 years to calculate annualized yield rate thereof and probability of rise and fall, and establishes countless models. A stock screening module selects one model, whose rising probability can reach about 80% or more, and whose annualized yield rate can reach one and several hundred percent or more, which is countless times much higher than an index increase, and sends the selected model the platform server, wherein the selected model is stored in the platform server for fully-automatic trading. This AI fully-automatic trading platform may enable a fully-automatic trading, which is easy to use. All investors can easily use the technical achievements brought by artificial intelligence innovation technology without writing programs. Specifically, the investors can conduct a fully-automatic trading with just a few mouse clicks. It is also possible to customize the addition of the underlying stocks and to conduct the fully-automatic trading. This not only enables them to completely liberate themselves from the heavy manual operations, but also obtains a yield rate countless times far higher than their own manual operations. In addition, it is possible to promote the stable and healthy development of the securities market. It can enable investors to obtain a yield rate that is countless times far stronger than the increase of the large-cap index, or far more than about 20% of the current model's annualized yield rate, thus achieving an annualized yield rate over one hundred or hundreds percent. Besides, systemic risks can be automatically avoided when all the large-cap indexes fall.

In order to achieve the above objects, the present invention provides an AI fully-automatic trading platform based on stock speculation robot, which includes a stock analyzing module, a stock data collecting module, a stock model establishing module, a stock screening module, a platform server and a fully-automatic trading platform. An output terminal of the stock analyzing module is connected to an input terminal of the stock data collecting module, and an output terminal of the stock data collecting module is connected to an input terminal of the stock model establishing module. An output terminal of the stock model establishing module is connected to an input terminal of the stock screening module, and an output terminal of the stock screening module is connected to an input terminal of the platform server, and the platform server is connected to the fully-automatic trading platform.

The stock analyzing module is configured to select a stock, which can rise by about 10% in substantially a next week and can reach about 80% or more after rising, by combining a monthly K-chart technical analysis with a fundamental analysis.

The stock data collecting module is configured to collect all technical indexes and data involved in the stock selected by the stock analyzing module at the closing of the stock selected, and to fix the technical indexes and data to a closing price on a closing day.

The stock model establishing module is configured, successively, to design a model by using a point position of the closing price on the closing day of the selected stock and dozens of the technical indexes or data thereof, to back-test, by using the model, historical data in past 5 to 10 years which experiences several bull and bear cycles, and calculate annualized yield rate thereof and probability of rise and fall, and to establish countless models, i.e., semi-finished universal quantitative models.

The stock screening module is configured to select one model, whose rising probability can reach about 80% or more, and whose annualized yield rate can reach one and several hundred percent or more, which is countless times much higher than an index increase, among the models established by the stock model establishing module, and to send the selected model the platform server, wherein the selected model is stored in the platform server for fully-automatic trading.

The platform server is configured to control, based on the model established by the stock model establishing module, the whole fully-automatic trading platform to perform stock speculation trading.

The fully-automatic trading platform is configured to provide a platform for stock speculation customers to use an artificial intelligence innovation technology conveniently to conduct the fully-automatic trading without writing programs.

In an embodiment, all the technical indexes and data involved in the stock selected by the stock analyzing module at the closing include: (5-day average price, 10-day average price, 20-day average price, 30-day average price, 60-day average price, 120-day average price, trading volume, turnover rate, various same average prices of the industry to which the selected stock belongs and other technical indexes) and seven fundamental surface factors.

In an embodiment, the seven fundamental surface factors include a price-to-book ratio, a price-to-earnings ratio, a dividend rate, a total A-share market value, a yield rate on net assets, a circulation disk greater than, and a circulation disk less than.

In an embodiment, the fully-automatic trading platform includes a semi-finished AI universal quantitative model selection module, a strategy writing module, a fundamental surface factor selection module, a de-risk factor selection module, a strategy factor combination back-testing module, a strategy saving module, a custom combination strategy underlying module, a custom trading fund bid-ask setting module, an automatic trading module and a real-time trading inquiry module, wherein the automatic trading module is fully operated by a network robot.

The invention also provides a use method of the AI fully-automatic trading platform based on a stock speculation robot. Embodiments of the method will now be described below.

Method 1: the method includes: logging into the fully-automatic trading platform, and selecting, according to requirements and preferences, seven fundamental surface factors and various de-risk factors, which can be more or less, among four functional columns, i.e., a semi-finished AI universal quantitative model selection module, a fundamental surface factor selection module, a de-risk factor selection module, and a custom trading fund bid-ask setting module.

Method 1 further includes: after the selection among the four functional columns, forming, in the strategy factor combination back-testing module, a set of strategies to back-test the historical data in the past 5 to 10 years so as to verify the annualized yield rate, the probability of rise and fall and other required parameters of the model, storing the strategies in the strategy saving module if the verifying is successful, and executing the strategies in the automatic trading module and viewing details of the strategies through the real-time trading inquiry module.

Method 2: the method includes: writing a strategy in the strategy writing module, executing the strategy in the automatic trading module, and viewing the details through the real-time trading inquiry module.

Method 3: the method also includes: adding stocks in the custom combination strategy underlying module, setting the stocks in the custom trading fund bid-ask setting module, executing the stocks in the automatic trading module, and viewing the details through the real-time trading inquiry module.

Technical effects and advantages of the present invention are as follows.

1. In the present invention, the stock analyzing module analyzes a stock, which can rise by about 10% in substantially a next week and can reach about 80% or more after rising. The stock data collecting module collects technical indexes and data at the closing of the stock selected. The stock model establishing module designs a model, back-tests, by using the model, historical data in past 5 to 10 years to calculate annualized yield rate thereof and probability of rise and fall, and establishes countless models. The stock screening module selects one model, whose rising probability can reach about 80% or more, and whose annualized yield rate can reach one and several hundred percent or more, which is countless times much higher than an index increase, and sends the selected model the platform server, wherein the selected model is stored in the platform server for fully-automatic trading. This AI fully-automatic trading platform may enable a fully-automatic trading, which is easy to use. All investors can easily use the technical achievements brought by artificial intelligence innovation technology without writing programs. Specifically, the investors can conduct a fully-automatic trading with just a few mouse clicks. It is also possible to customize the addition of the underlying stocks and to conduct the fully-automatic trading. This not only enables them to completely liberate themselves from the heavy manual operations, but also obtains a yield rate countless times far higher than their own manual operations. In addition, it is possible to promote the stable and healthy development of the securities market.

2. In the present invention, it is possible to enable the investors to obtain a yield rate that is countless times far stronger than the increase of the large-cap index, or far more than about 20% of the current model's annualized yield rate, thus achieving an annualized yield rate over one hundred or hundreds percent. Besides, it is possible to automatically avoid systemic risks when all the large-cap indexes fall.

### BRIEF DESCRIPTION OF THE DRAWINGS

FIG. 1 is a schematic view showing an AI fully-automatic trading platform based on a stock speculation robot according to the present invention.

FIG. 2 is a schematic view of a fully-automatic trading platform according to the present invention.

The reference numerals are: 1, stock analyzing module; 2, stock data collecting module, 3, stock model establishing module; 4, platform server; 5, fully-automatic trading platform.

### DETAILED DESCRIPTION OF EMBODIMENTS

The technical solutions in the embodiments of the present invention are clearly and completely described in the following with reference to the accompanying drawings in embodiments of the present invention. It is obvious that the described embodiments are only a part of the embodiments of the present invention, but not all embodiments. All other embodiments obtained by those skilled in the art based on the embodiments of the present invention without creative efforts are within the scope of the present invention.

### Embodiment 1

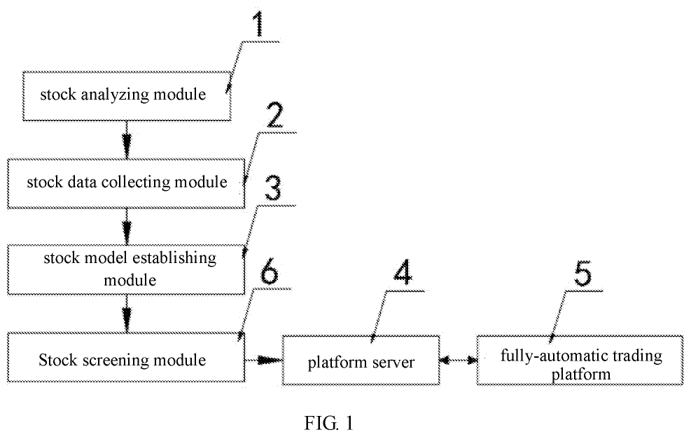

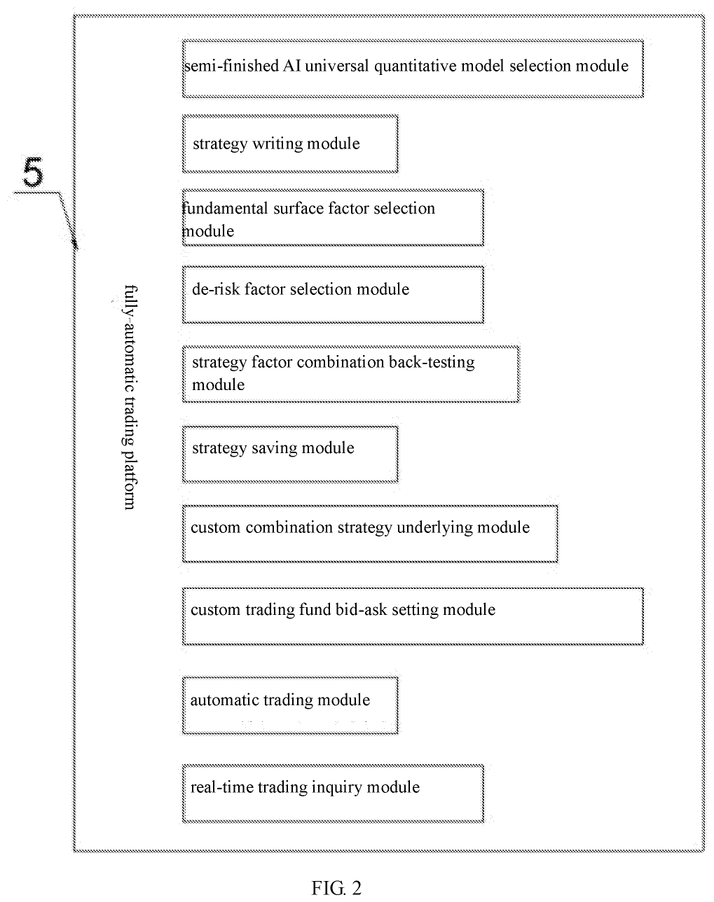

An AI fully-automatic trading platform based on stock speculation robot shown in FIGS. 1-2, includes a stock analyzing module 1, a stock data collecting module 2, a stock model establishing module 3, a stock screening module 6, a platform server 4 and a fully-automatic trading platform 5. An output terminal of the stock analyzing module 1 is connected to an input terminal of the stock data collecting module 2. An output terminal of the stock data collecting module 2 is connected to an input terminal of the stock model establishing module 3. An output terminal of the stock model establishing module 3 is connected to an input terminal of the stock screening module 6. An output terminal of the stock screening module 6 is connected to an input terminal of the platform server 4. The platform server 4 is connected to the fully-automatic trading platform 5.

The stock analyzing module 1 is configured to select a stock, which can rise by about 10% in substantially a next week and can reach about 80% or more after rising, by combining a monthly K-chart technical analysis with a fundamental analysis. For example, the 300682 Langxin Technology was selected after the close at 3 pm on May 25, 2018, whose price of the K-chart was closed at 22.05. It is needed to predict whether the probability of its stock price rising by about 10% in the next week can reach 80% or above.

The stock data collecting module 2 is configured to collect all technical indexes and data involved in the stock selected by the stock analyzing module 1 at the closing of the stock selected, and to fix the technical indexes and data to a closing price on a closing day.

All the technical indexes and data involved in the stock selected by the stock analyzing module 1 at the closing comprise: (5-day average price, 10-day average price, 20-day average price, 30-day average price, 60-day average price, 120-day average price, trading volume, turnover rate, various same average prices of the industry to which the selected stock belongs and other technical indexes) and seven fundamental surface factors.

The stock model establishing module 3 is configured, successively, to design a model, by using a point position of the closing price on the closing day of the selected stock and dozens of the technical indexes or data thereof, to back-test, by using the model, historical data in past 5 to 10 years which experiences several bull and bear cycles, and calculate annualized yield rate thereof and probability of rise and fall, and to establish countless models, i.e., semi-finished universal quantitative models.

The stock screening module 6 is configured to select one model, whose rising probability can reach about 80% or more, and whose annualized yield rate can reach one and several hundred percent or more, which is countless times much higher than an index increase, among the models established by the stock model establishing module 3, and to send the selected model the platform server 4, where the selected model is stored in the platform server 4 for fully-automatic trading.

The seven fundamental surface factors comprise: a price-to-book ratio, a price-to-earnings ratio, a dividend rate, a total A-share market value, a yield rate on net assets, a circulation disk greater than, and a circulation disk less than.

The platform server 4 is configured to control, based on the model established by the stock model establishing module 3, the whole fully-automatic trading platform 5 to perform stock speculation trading.

The fully-automatic trading platform 5 is configured to provide a platform for stock speculation customers to use an artificial intelligence innovation technology conveniently to conduct the fully-automatic trading without writing programs.

The stock analyzing module 1 analyzes a stock, which can rise by about 10% in substantially a next week and can reach about 80% or more after rising. The stock data collecting module 2 collects technical indexes and data at the closing of the stock selected. The stock model establishing module 3 designs a model, back-tests, by using the model, historical data in past 5 to 10 years to calculate annualized yield rate thereof and probability of rise and fall, and establishes countless models. The stock screening module 6 selects one model, whose rising probability can reach about 80% or more, and whose annualized yield rate can reach one and several hundred percent or more, which is countless times much higher than an index increase, and sends the selected model the platform server 4, where the selected model is stored in the platform server 4 for fully-automatic trading. The AI fully-automatic trading platform 5 may enable a fully-automatic trading, which is easy to use. All investors can easily use the technical achievements brought by artificial intelligence innovation technology without writing programs. Specifically, the investors can conduct a fully-automatic trading with just a few mouse clicks. It is also possible to customize the addition of the underlying stocks and to conduct the fully-automatic trading. This not only enables them to completely liberate themselves from the heavy manual operations, but also obtains a yield rate countless times far higher than their own manual operations. In addition, it is possible to promote the stable and healthy development of the securities market.

### Embodiment 2

The fully-automatic trading platform 5 comprises a semi-finished AI universal quantitative model selection module, a strategy writing module, a fundamental surface factor selection module, a de-risk factor selection module, a strategy factor combination back-testing module, a strategy saving module, a custom combination strategy underlying module, a custom trading fund bid-ask setting module, an automatic trading module and a real-time trading inquiry module, where the automatic trading module is fully operated by a network robot.

The finished interface of the entire fully-automatic trading platform 5 consists of the above 10 functional modules, each of which has its own unique role and can be operated in its function column. The detail is as follows.

AI universal quantitative model selection module functional area: There are 180 semi-finished universal quantitative models therein. The program is written in Python language. Each model is composed of more than 30 kinds of factors, combined with fundamental surface and de-risk factors. The parameter design of the two functional blocks, i.e., the strategy factor combination back-testing module and the custom trading fund bid-ask setting module, can be selected. The yield rate thereof is back-tested by using the historical data in the period of past 5 to 10 years. If the yield rate reaches the ideal annualized yield rate, e.g., about 100% and 500% or more per year, or over countless times increase of the large-cap index in the same period, it will be saved in the strategy saving area. The strategy saving area can save multiple strategies and jointly carry out fully-automatic trading. After being saved, a click may be performed to start a fully-automatic trading.

Custom writing functional area: Users can write programs by themselves in Python language. On this platform, it is possible to back-test the historical data, verify whether the annualized yield rate of the strategy meets the requirements, save corresponding dates for reserving, and conduct fully-automatic trading.

Fundamental surface factor functional column: Because of the large number of the customers who use the platform, each customer can select these seven fundamental surface factors according to their own requirements and preferences. Also, the selected fundamental surface factors can be more or less. Four functional modules, i.e., the semi-finished AI universal quantitative model, the fundamental surface factor selection module, the strategy factor combination back-testing module, and the custom trading fund bid-ask setting module, can be combined into one complete fully-automatic trading model.

The function of the de-risk factor column: Like the fundamental surface factor selection module, each de-risk factor can be selected according to the customer's requirements. The selected de-risk factor can be combined into one complete fully-automatic trading model with the semi-finished AI universal quantitative model, the fundamental surface factor selection module, the strategy factor combination back-testing module, and the custom trading fund bid-ask setting module.

The function of the strategy factor combination back-testing column: After the semi-finished AI universal quantitative model, the fundamental surface factor selection module, the strategy factor combination back-testing module, and the custom trading fund bid-ask setting module being designed, the historical data back-testing can be performed in this column, to verify, by using the historical data, the model's annualized yield rate in the period of past 5 to 10 years and the probability of rise and fall and other required parameters. If the verifying is successful, it may be saved in the strategy saving module, so as to conduct the fully-automatic trading.

The function of the strategy saving area column: The models, satisfying the requirements after back-testing in combination by the semi-finished AI universal quantitative models, the fundamental surface factor selection module, the strategy factor combination back-testing module, and the custom trading fund bid-ask setting module, can be saved therein. Then, the models may be connected with the automatic trading module for fully-automatic trading. The operation result may be displayed in the real trading query module function block for fully-automatic trading.

The function of the custom adding column: Customers can select the stocks to be operated on other market software according to their own requirements and directly add them in this column. Also, the customers can connect them with the custom trading fund bid-ask setting module and automatic trading module for fully-automatic trading.

The function of the custom trading fund setting column: The customers can set the buying price of the operating stock, the take profit price, the stop loss price, and the allocation ratio of the fund according to their own hobbies.

The function of the robot fully-automatic real-time operation function block: After other function blocks being set, the automatic trading module can be clicked, when the strategy saved in the saving area needs to be traded. The robot will automatically perform the operation for fully-automatic trading. Results of the operation can be queried by the real trading query module function block.

Real-time trading inquiry: All the trading results can be queried here. A person can also purchase new shares with one-click or perform clearance function with one click.

### Embodiment 3

The invention also provides a use method of the AI fully-automatic trading platform based on stock speculation robot. The use method is described in detail as follows.

Method 1: the customer logs into the fully-automatic trading platform 5, and selects, according to their own requirements and preferences, seven fundamental surface factors and various de-risk factors, which can be more or less, among four functional columns, i.e., a semi-finished AI universal quantitative model selection module, a fundamental surface factor selection module, a de-risk factor selection module, and a custom trading fund bid-ask setting module.

After the selection among the four functional columns, the method includes forming, in the strategy factor combination back-testing module, a set of strategies to back-test the historical data in the past 5 to 10 years so as to verify the annualized yield rate, the probability of rise and fall and other required parameters of the model, storing them in the strategy saving module if the verifying is successful, and executing them in the automatic trading module and viewing details thereof through the real-time trading inquiry module;

Method 2: the method includes writing a strategy in the strategy writing module, executing the strategy in the automatic trading module, and viewing the details through the real-time trading inquiry module.

Method 3: the method includes adding stocks in the custom combination strategy underlying module, setting the stocks in the custom trading fund bid-ask setting module, executing the stocks in the automatic trading module, and viewing the details through the real-time trading inquiry module.

It should be noted, that the terms “installation”, “connected”, and “connection”, in the description of the present application, should be understood broadly. It may refer to a mechanically connection, or electrical connection, or the internal connection between two components, or a directly connecting between them, unless otherwise specified or defined. Terms, such as “up”, “down”, “left”, “right”, etc. are only used to indicate the relative positional relationship. When the absolute position of the object to be described changes, the relative positional relationship may change.

In the drawings of the disclosed embodiments of the present invention, only the structures related to the embodiments of the present disclosure are involved. Other structures may refer to the general design. Without being conflict, the same embodiment and different embodiments of the present invention may be combined with each other.

The above description is only for the preferred embodiment of the present invention, but not intended to limit the present invention. Any modifications, equivalent substitutions, improvements, etc., made within the spirit and principles of the present invention, should be included within the protection scope of the present invention.

What is claimed is:

1. An AI fully-automatic trading platform based on a stock speculation robot, comprising a stock analyzing module, a stock data collecting module, a stock model establishing module, a stock screening module, a platform server and a fully-automatic trading platform;
wherein an output terminal of the stock analyzing module is connected to an input terminal of the stock data collecting module; an output terminal of the stock data collecting module is connected to an input terminal of the stock model establishing module; an output terminal of the stock model establishing module is connected to an input terminal of the stock screening module; an output terminal of the stock screening module is connected to an input terminal of the platform server; and the platform server is connected to the fully-automatic trading platform;
the stock analyzing module is configured to select a stock which can rise by about 10% in substantially a next week and can reach about 80% or more after rising, by combining a monthly K-chart technical analysis with a fundamental analysis;
the stock data collecting module is configured to collect all technical indexes and data involved in the stock selected by the stock analyzing module at the closing of the stock selected, and to fix the technical indexes and data to a closing price on a closing day;
the stock model establishing module is configured, successively, to design a model by using a point position of the closing price on the closing day of the selected stock and dozens of the technical indexes or data thereof, to back-test, by using the model, historical data in past 5 to 10 years which experiences several bull and bear cycles, to calculate an annualized yield rate thereof and a probability of rise and fall, and to establish countless models, i.e., semi-finished universal quantitative models;
the stock screening module is configured to select one model whose rising probability can reach about 80% or more, and whose annualized yield rate can reach one and several hundred percent or more, which is countless times much higher than an index increase, among the models established by the stock model establishing module, and to send the selected model to the platform server, wherein the selected model is stored in the platform server for fully-automatic trading;
the platform server is configured to control, based on the model established by the stock model establishing module, the fully-automatic trading platform to perform stock speculation trading; and
the fully-automatic trading platform is configured to provide a platform for stock speculation customers to use an artificial intelligence innovation technology conveniently to conduct the fully-automatic trading without writing programs.

2. The AI fully-automatic trading platform of claim 1, wherein all the technical indexes and data involved in the stock selected by the stock analyzing module at the closing comprise: (5-day average price, 10-day average price, 20-day average price, 30-day average price, 60-day average price, 120-day average price, trading volume, turnover rate, various same average prices of the industry to which the selected stock belongs and other technical indexes) and seven fundamental surface factors.

3. The AI fully-automatic trading platform of claim 2, wherein the seven fundamental surface factors comprise a price-to-book ratio, a price-to-earnings ratio, a dividend rate, a total A-share market value, a yield rate on net assets, a circulation disk greater than and a circulation disk less than.

4. The AI fully-automatic trading platform of claim 1, wherein the fully-automatic trading platform comprises a semi-finished AI universal quantitative model selection module, a strategy writing module, a fundamental surface factor selection module, a de-risk factor selection module, a strategy factor combination back-testing module, a strategy saving module, a custom combination strategy underlying module, a custom trading fund bid-ask setting module, an automatic trading module and a real-time trading inquiry module, wherein the automatic trading module is fully operated by a network robot.

5. A use method of the AI fully-automatic trading platform of claim 1, comprising:
operating the AI fully-automatic trading platform by the following methods:
method 1: a customer logging into the fully-automatic trading platform, and selecting, according to their own requirements and preferences, seven fundamental surface factors and various de-risk factors, which can be more or less, among four functional columns, i.e., a semi-finished AI universal quantitative model selection module, a fundamental surface factor selection module, a de-risk factor selection module, and a custom trading fund bid-ask setting module;
after the selection among the four functional columns, forming, in the strategy factor combination back-testing module, a set of strategies to back-test the historical data in the past 5 to 10 years so as to verify the annualized yield rate, the probability of rise and fall and other required parameters of the model; storing the strategies in the strategy saving module if the verifying is successful, and executing the strategies in the automatic trading module and viewing details of the strategies through the real-time trading inquiry module;
method 2: writing a strategy in the strategy writing module, executing the strategy in the automatic trading module, and viewing the details through the real-time trading inquiry module;
method 3: adding stocks in the custom combination strategy underlying module, setting the stocks in the custom trading fund bid-ask setting module, executing the stocks in the automatic trading module, and viewing the details through the real-time trading inquiry module.

6. A use method of the AI fully-automatic trading platform of claim 2, comprising:
operating the AI fully-automatic trading platform by the following methods:
method 1: a customer logging into the fully-automatic trading platform, and selecting, according to their own requirements and preferences, seven fundamental surface factors and various de-risk factors, which can be more or less, among four functional columns, i.e., a semi-finished AI universal quantitative model selection module, a fundamental surface factor selection module, a de-risk factor selection module, and a custom trading fund bid-ask setting module;
after the selection among the four functional columns, forming, in the strategy factor combination back-testing module, a set of strategies to back-test the historical data in the past 5 to 10 years so as to verify the annualized yield rate, the probability of rise and fall and other required parameters of the model; storing the strategies in the strategy saving module if the verifying is successful, and executing the strategies in the automatic trading module and viewing details of the strategies through the real-time trading inquiry module;
method 2: writing a strategy in the strategy writing module, executing the strategy in the automatic trading module, and viewing the details through the real-time trading inquiry module;
method 3: adding stocks in the custom combination strategy underlying module, setting the stocks in the custom trading fund bid-ask setting module, executing the stocks in the automatic trading module, and viewing the details through the real-time trading inquiry module.
